(19) United States
(12) Patent Application Publication
(10) Pub. No.: US 2019/0315602 A1
(43) Pub. Date: Oct. 17, 2019

(54) REVERSE LUFFING AND UTILITY BOOM CRANES

(71) Applicant: NATIONAL OILWELL VARCO, L.P., Houston, TX (US)

(72) Inventors: James William Weir, Cypress, TX (US); Frank Benjamin Springett, Spring, TX (US); Travis James Miller, Cypress, TX (US)

(21) Appl. No.: 16/381,864

(22) Filed: Apr. 11, 2019

Related U.S. Application Data
(60) Provisional application No. 62/656,235, filed on Apr. 11, 2018.

(51) Int. Cl. B66C 23/06; B66C 23/52; B66C 23/82

(52) U.S. Cl. CPC B66C 23/06; B66C 23/82; B66C 23/52

(57) ABSTRACT

Cranes and crane systems with high capacity lifting capabilities, as well as versatility and relatively large operational areas. A crane of the present disclosure may have main boom pivotable about a substantially horizontal axis and a luffing assembly configured for luffing the boom about the axis. The main boom may be pivotable in both a forward luffing operation and a reverse or rearward luffing operation. In this way, the main boom may be operable within a range extending up to 180 degrees. Various adjustment mechanisms may be used to shift the main boom from a forward luffing operation to a reverse luffing operation. Additionally, a crane of the present disclosure may have a utility boom rotatable about a substantially vertical axis. The utility boom may allow for added lateral reach of the crane, thus further increasing the operational area of the crane.

### CROSS-REFERENCE TO RELATED APPLICATION

This patent application claims the benefit of U.S. Provisional Patent Application No. 62/656,235, filed Apr. 11, 2018, which is incorporated by reference herein in its entirety.

### FIELD OF THE INVENTION

The present disclosure relates to novel and advantageous cranes and crane systems. Particularly, the present disclosure relates to novel and advantageous cranes and crane systems having improved operational areas. More particularly, the present disclosure relates to shear leg cranes configured for forward luffing operations and reverse luffing operations. Additionally, the present disclosure relates to cranes having laterally pivotable utility booms in addition to main booms.

### BACKGROUND OF THE INVENTION

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Lifting devices such as cranes are used for hoisting and moving loads for various applications, both on and off-shore. One common type of crane is a rotational crane, having a boom rotatable on a pedestal or bearing. Rotational cranes may provide a relatively wide range of motion, in comparison to other types of crane, by virtue of their rotatability. On marine vessels, rotational cranes are frequently used for transporting loads on, to, or from a deck of the vessel. However, rotational cranes may be relatively expensive, requiring relatively complex rotational and other mechanisms. Moreover, rotational cranes may have a relatively low lifting capacity, in comparison with other types of cranes. Another common type of crane used in both on and off-shore operations is a shear leg crane, having a boom pivotable about a generally horizontal axis. Shear leg cranes may provide relatively high lifting capacities, in comparison with other cranes. However, shear leg cranes may have a relatively limited range of motion, as compared with, for example, rotational cranes. For example, the pivotable boom of a shear leg crane may become relatively unstable at angles at or near 85 degrees or 90 degrees from horizontal, particularly when lifting a load. Moreover, shear leg cranes are conventionally unable to rotate beyond 85 degrees or 90 degrees from horizontal.

For some applications, cranes may be used in tandem to move relatively large loads. When cranes are used in tandem, operational windows of the cranes may be limited by the need for both cranes to be able to reach the load. For example, where rotational cranes are used in tandem, the load may be arranged between the two cranes, and the operational windows of the tandem system may be limited by the need for each crane to reach the load. While reach may be increased by increasing the size of the cranes, this may lead to more expensive cranes that require more space.

### BRIEF SUMMARY OF THE INVENTION

The following presents a simplified summary of one or more embodiments of the present disclosure in order to provide a basic understanding of such embodiments. This summary is not an extensive overview of all contemplated embodiments, and is intended to neither identify key or critical elements of all embodiments, nor delineate the scope of any or all embodiments.

The present disclosure, in one or more embodiments, relates to a reverse luffing crane having a crane boom extending from a proximal end at or near a base to a distal end, the crane boom being pivotable about a substantially horizontal axis at the proximal end. In addition, the crane may have a luffing assembly configured for pivoting the crane boom about the axis. The luffing assembly may include a back stay frame and a winch assembly configured for controlling the pivoted position of the crane boom relative to the back stay frame. The crane may additionally have an adjustment mechanism configured to controllably transition the crane boom from a forward luffing position to a reverse luffing position, the adjustment mechanism having a catch for controlling the rearward motion of the crane boom relative to the back stay frame. In some embodiments, the adjustment mechanism may include a collapsible leg of the back stay frame. The collapsible leg may be a telescoping element or a parallel sliding mechanism, for example. The adjustment mechanism may include a frame shoe configured to allow a leg of the back stay frame to controllably pass therethrough. In some embodiments, the luffing assembly may be configured to control the motion of the leg through the frame shoe and the resulting reverse motion of the crane boom. Moreover, the crane may have a utility boom extending generally laterally from the crane boom and arranged at or near the distal end of the crane boom. The utility boom may be pivotable about a generally vertical axis. In some embodiments, the utility boom may be configured to engage a second utility boom extending from an adjacent crane.

The present disclosure, in one or more embodiments, additionally relates to a shear leg crane having a crane boom extending from a proximal end at or near a base to a distal end, the crane boom being pivotable about a substantially horizontal axis at the proximal end. The crane may have a luffing assembly configured for pivoting the crane boom about the axis. The luffing assembly may include a back stay frame and a winch assembly configured for controlling the pivoted position of the crane boom relative to the back stay frame. Moreover, in some embodiments, the crane may include a utility boom extending generally laterally from the crane boom and arranged at or near the distal end of the crane boom, the utility boom being pivotable about a generally vertical axis. The utility boom may be configured to engage a second utility boom extending from an adjacent crane. Further, in some embodiments, the crane may have an adjustment mechanism for controllably transitioning the crane boom forward luffing position to a reverse luffing position, the adjustment mechanism including a catch for controlling the rearward motion of the crane boom relative to the back stay frame. The adjustment mechanism may include a collapsible leg of the back stay frame. In some embodiments, the adjustment mechanism may include a frame shoe configured to allow a leg of the back stay frame to controllably pass therethrough.

The present disclosure, in one or more embodiments, additionally relates to a method of operating a shear leg crane having a crane boom pivotable about a substantially horizontal axis and a luffing assembly configured for pivoting the crane boom about the axis. The method may include the steps of, in a forward luffing operation, luffing the main boom to a near-vertical position, and securing the main boom. The method may additionally include controllably transitioning the crane boom from a forward luffing position to rearward luffing position, and controllably luffing the main boom in a reverse luffing operation. In some embodiments, the luffing assembly may include a back stay frame, and the step of controllably transitioning the crane boom from a forward luffing position to a rearward luffing position may include lowering a leg of the back stay frame. In other embodiments, transitioning the crane boom from a forward luffing position to a rearward luffing position may include collapsing a leg of the back stay frame. In still other embodiments, transitioning the crane boom from a forward luffing position to a rearward luffing position may include controllably passing a leg of the back stay frame through a frame shoe.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1 is a perspective view of a crane system of the present disclosure, according to one or more embodiments.

FIG. 2 is a side view of the crane system of FIG. 1, according to one or more embodiments.

FIG. 3 is another perspective view of the crane system of FIG. according to one or more embodiments.

FIG. 4 is a side view of the crane system of FIG. 1, according to one or more embodiments.

FIG. 5 is another perspective view of the crane system of FIG. 1, according to one or more embodiments.

FIG. 6 is another perspective view of the crane system of FIG. 1, according to one or more embodiments.

FIG. 7 is another perspective view of the crane system of FIG. 1, according to one or more embodiments.

FIG. 8 is another perspective view of the crane system of FIG. according to one or more embodiments.

FIG. 9 is another perspective view of the crane system of FIG. 1, according to one or more embodiments.

FIG. 10 is a flow diagram of a method of shifting a crane from a forward luffing operation to a reverse luffing operation, according to one or more embodiments.

FIG. 11 is a side view of the crane system of FIG. 1, with a main boom being luffed in a forward luffing operation, according to one or more embodiments.

FIG. 12 is a side view of the crane system of FIG. 1, with a main boom being luffed in a forward luffing operation, according to one or more embodiments.

FIG. 13 is a side view of the crane system of FIG. 1, with a main boom being luffed in a forward luffing operation to a near-vertical position, according to one or more embodiments.

FIG. 14 is a side view of the crane system of FIG. 1, with an adjustment mechanism of one crane adjusting the crane to shift the main boom from a forward luffing position to a reverse luffing position, according to one or more embodiments.

FIG. 15 is a side view of the crane system of FIG. 1, with a main boom being luffed in a reverse luffing operation, according to one or more embodiments.

FIG. 16 is a perspective view of a crane system of the present disclosure, according to one or more embodiments.

FIG. 17 is a side view of a crane system of the present disclosure, with a main boom being luffed in a forward luffing operation, according to one or more embodiments.

FIG. 18 is a side view of the crane system of FIG. 16, with a main boom being luffed in a forward luffing operation to a near-vertical position, according to one or more embodiments.

FIG. 19 is a side view of the crane system of FIG. 16, with an adjustment mechanism adjusting a leg of a back stay frame to shift a main boom from a forward luffing position to a reverse luffing position, according to one or more embodiments.

FIG. 20 is a side view of the crane system of FIG. 16, with a leg of a back stay frame being unpinned to allow a reverse luffing operation, according to one or more embodiments.

FIG. 21 is a side view of the crane system of FIG. 16, with a main boom being luffed in a reverse luffing operation, according to one or more embodiments.

FIG. 22 is a side view of the crane system of FIG. 16, with a main boom being luffed in a reverse luffing operation, according to one or more embodiments.

FIG. 23 is a side view of a crane system of the present disclosure, according to one or more embodiments.

FIG. 24 is a plan view of a rotational crane system footprint and an operational area of the crane system.

FIG. 25 is a plan view of a shear leg crane system and an operational area of the crane system.

FIG. 26 is a plan view of a crane system of the present disclosure and an operational area of the crane system, according to one or more embodiments.

FIG. 27 is a plan view of a crane system of the present disclosure and an operational area of the crane system, according to one or more embodiments.

FIG. 28 is a plan view of an operational area of a rotational crane system overlaid with a plan view of an operational area of a crane system of the present disclosure, according to one or more embodiments.

### DETAILED DESCRIPTION

The present disclosure relates to cranes and crane systems with high capacity lifting capabilities, as well as versatility and relatively large operational areas. In some embodiments, a crane of the present disclosure may have main boom pivotable about a substantially horizontal axis and a luffing assembly configured for luffing the boom about the axis. The main boom may be pivotable in both a forward luffing operation and a reverse or rearward luffing operation. The forward luffing operation may be a rotational range of the boom within a first 90-degree quadrant defined by a horizontal plane and a vertical plane. The reverse or rearward lulling operation may be a rotational range of the boom within a second 90-degree quadrant defined by the same horizontal and vertical planes. In this way, the main boom may be operable within a range extending up to 180 degrees, or even larger where the boom can rotate downward from horizontal. Various adjustment mechanisms may be used to shift the main boom from a forward luffing operation to a reverse luffing operation, and to luff the main boom in a reverse luffing operation. For example, some adjustment mechanisms may include a sliding frame shoe that operates to slide a leg of the back stay frame outward, thus causing the back stay frame to flatten against a platform on which the crane is arranged, and the main boom to shift. In other embodiments, an adjustment mechanism may include a collapsible leg of the back stay frame configured to controllably collapse a leg of the frame to, thus causing the opposing leg of the back stay frame to lay back and the main boom to shift. In other embodiments, an adjustment mechanism may include a mechanism for lowering a leg of the back stay frame below a platform in on which the crane is arranged, thus causing the opposing leg of the back stay frame to lay back and the main boom to shift. In still other embodiments, other adjustment mechanisms may be used. Additionally, a crane of the present disclosure may have a utility boom rotatable about a substantially vertical axis. The utility boom may allow for added lateral reach of the crane, thus further increasing the operational area of the crane. Moreover, the utility boom may be configured to couple to or engage with a utility boom of an adjacent crane, to operate as a spreader beam between the two adjacent cranes.

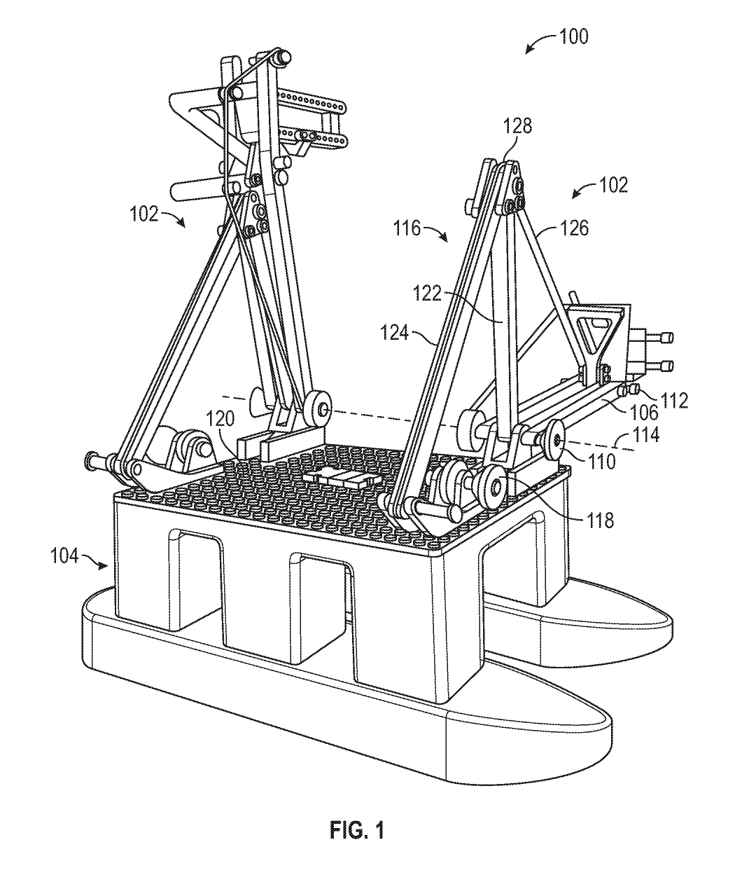

Turning now to FIG. 1, a crane system 100 of the present disclosure is shown, according to one or more embodiments. The crane system 100 may have at least one crane 102 configured for hoisting and moving a load. In some embodiments, the system 100 may be a tandem crane system having a pair of cranes 102 configured for tandem hoisting operations. Each crane 102 may have a pivotable main boom 106 and a luffing assembly for pivoting the boom. The one or more cranes 102 may be arranged on a base structure 104 sized and configured for supporting the crane(s). In some embodiments, cranes 102 may be arranged on separate base structures 104.

The base structure 104 may provide a platform 120 on which the one or more cranes 102 may be arranged. In some embodiments, the platform 120 may have devices or mechanisms for interface with the one or more cranes 102. For example, the platform 120 may have brackets, hubs, ears, or other structures for interfacing with the main boom 106 and/or components of the luffing assembly. The one or more cranes 102 may be permanently or removably arranged on the base structure 104. The base structure 104 may be or include an on or off-shore structure. For example, the base structure 104 may be or include a marine vessel, a portion thereof, or may be configured to be arranged on a marine vessel, barge, platform, or other marine device or structure. In other embodiments, the base structure 104 may be configured for on-shore use. In still other embodiments, the one or more cranes 102 may be arranged on a ground surface.

In some embodiments, each crane 102 may be, or may include components associated with, what may commonly be referred to as a shear leg crane. That is, in some embodiments, each crane 102 may have a main boom 106 pivotable about a substantially horizontal axis 114, and a luffing assembly configured for pivoting the boom about the axis, and having a back stay frame 116 and a winch assembly 118. In other embodiments, each of the one or more cranes 102 may be or include a different style of crane or hoisting assembly.

The main boom 106 of each crane 102 may be an elongate structure extending from a location on or near the base structure 104. The main boom 106 may have a proximal end 110 arranged at or near the base structure 104, and a distal end 112 opposite the proximal end. The proximal end 110 may be pivotably coupled to a leg of the back stay frame 116, as described below. In other embodiments, the proximal end 110 may be pivotably coupled to the platform 120. The main boom 106 may be pivotable about an axis, such as a substantially horizontal axis 114 at or near its proximal end 110. For example, the substantially horizontal axis 114 may extend through the proximal end of the main boom 106, as shown in FIG. 1. The main boom 106 may have a length extending between the proximal 110 and distal ends 112 of between approximately 50 meters and approximately 200 meters, or between approximately 62.5 meters and approximately 150 meters, or between approximately 75 meters and approximately 125 meters. In some embodiments, the main boom 106 may have a length of approximately 100 meters. In still other embodiments, the main boom 106 may have a length of less than 50 meters or of more than 200 meters.

The main boom 106 may be configured to withstand compressive and bending loads induced therein during operation by the weight of material and/or equipment lifted, moved, or otherwise handled by the crane system 100. The main boom 106 may include built-up, hot-rolled, or cold-rolled steel structures or other steel structures. Other materials such as composite materials or other materials may be used. Internal stiffeners, braces, hacking bars, and/or other design, fabrication, or erection related features may be provided. In some embodiments, the main boom 106 may be or include a lattice boom. In some embodiments, the main boom 106 may have a generally rectangular or square cross-sectional shape. In some embodiments, a cross section of the main boom 106 may be varied to provide a tapered boom that narrows as it extends from the proximal end 110 to the distal end 112, or is relatively constant in cross section prior to the luffing line and tapered thereafter.

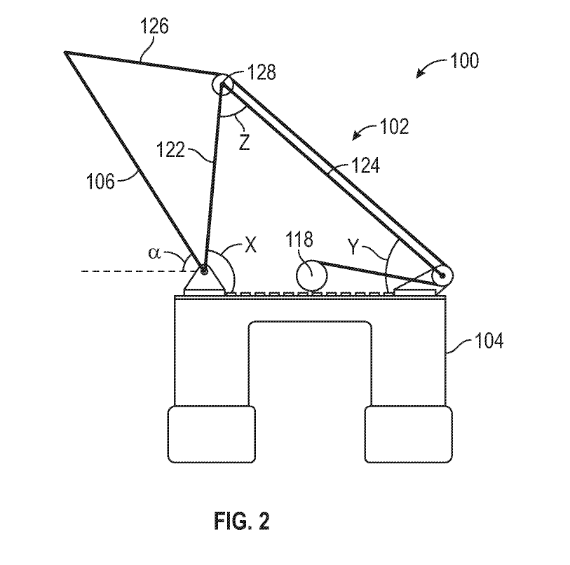

The luffing assembly for the main boom 106 of the crane 102 may include a back stay frame 116 mounted to, or otherwise arranged on, the platform 120. The back stay frame 116 may be or include an A-shaped structure (or A-frame) having a front member or leg 122 and a rear member or leg 124. The front leg 122 may extend from the platform 120 at a location at or near the proximal end 110 of the main boom 106. In some embodiments, the front leg 122 may extend generally or nearly vertically or perpendicularly from the platform 120. That is, the front leg 122 may extend from the platform 120 with an included angle x relative to the platform of approximately 80, 85, or 90 degrees, as shown in FIG. 2. The rear leg 124 may extend from the platform 120 at a location further away from the main boom 106. As additionally shown in FIG. 2, the rear leg 124 may extend from the platform 120 at an included angle y relative to the platform 120 of less than 90 degrees, such as an angle of approximately 45, 50, or 55 degrees. In other embodiments, the front 122 and rear 124 legs of the frame 116 may extend from the platform 120 at other suitable angles. Each of the front 122 and rear 124 legs may extend from their respective positions on the platform 120 to a intersecting point, which may generally be the top or peak of the A-shaped structure. As shown in FIG. 2, the front 122 and rear 124 legs of the frame 116 may meet with an included angle z between them of less than 90 degrees, such as approximately 40, 45, or 50 degrees. In some embodiments, the front 122 and rear 124 legs may pivotably couple to one another. That is, a pivotable joint may be arranged at the top or peak of the A-shaped structure.

With reference back to FIG. 1, the luffing assembly of each crane 102 may additionally have a winch assembly 118 with a winch drum about which a cable or line 126 may be coiled. The winch assembly 118 and line 126 may be configured for controllably pivoting the main boom 106 about the axis 114. The winch assembly 118 may be arranged on the platform 120, at or near the rear leg 124 of the back stay frame 116. The line 126 extending from the winch assembly 118 may extend up the rear leg 124 and over the intersecting point of the front 122 and rear legs. A sheave assembly 128 having one or more sheaves may be arranged at the top of the back stay frame 116 in some embodiments. The line 126 may be arranged through the sheave assembly 128, and may further extend to the main boom 106, such as to a location at or near the distal end 112 of the boom. In some embodiments, a sheave assembly may additionally be arranged at or near an end of the rear leg 124 near the platform 120, such that the line 126 may extend from the winch 118, across this sheave assembly near the platform, and up the rear leg to the sheave assembly 128.

The main boom 106 may be luffed (i.e., rotated about the axis 114) using the winch assembly 118. That is, as the line 126 is taken up by the winch 118, the main boom 106 may be rotated about the axis 114, such that the distal end 112 moves toward the top of the back stay frame 116. As the line 126 is let out by the winch 118, the main boom 106 may be rotated about the axis 114, such that the distal end 112 moves away from the top of the back stay frame 116. With reference to FIG. 2, the main boom 106 may be luffed to a luffing angle α, defined between the main boom and a horizontal plane. The main boom 106 may generally be luffed in this way between a horizontal or near horizontal position to a vertical or near vertical position. Luffing in this way, substantially within a first quadrant defined between a horizontal plane and a vertical plane, may be referred to herein as forward luffing. Forward luffing may generally operate to rotate the main boom 106 in front of the front leg 122. In a forward luffing operation, the main boom 106 may be luffed to a luffing angle α of between approximately 0 degrees and approximately 90 degrees, or between approximately 0 degrees and approximately 85 degrees. In some embodiments, the main boom 106 may be luffed to an angle α below zero degrees.

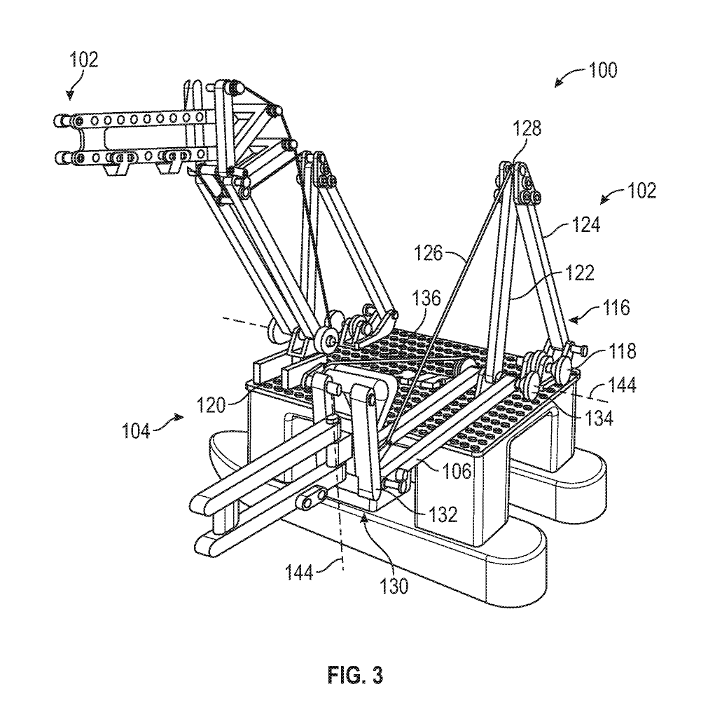

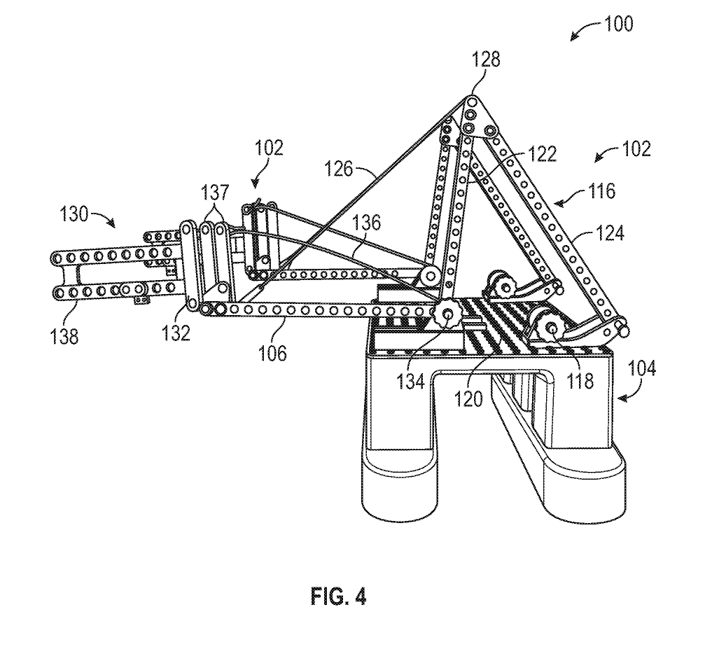

In some embodiments, the main boom 106 may have a jib assembly 130, as may be seen for example in FIGS. 3 and 4. The jib assembly 130 may be configured to extend the reach of the main boom 106 and to provide additional functionality. The jib assembly 130 may include an extension portion 132 pivotably extending from the distal end 112 of the main boom 106. The extension portion 132 may be configured to pivot about a substantially horizontal axis arranged at the distal end 112 of the main boom 106. The horizontal axis about which the extension portion 132 pivots may be parallel to the axis 114 about which the boom 106 pivots. The extension portion 132 may have a length extending from the boom 106 of between approximately 10 meters and approximately 40 meters, or between approximately 12.5 meters and approximately 30 meters, or between approximately 15 meters and approximately 25 meters. In some embodiments, the extension portion 132 may have a length of approximately 20 meters. In other embodiments, the extension portion 132 may have a length of less than 10 meters, or of more than 40 meters. In some embodiments, the extension portion 132 may have a length of approximately ⅕ that of the main boom 106.

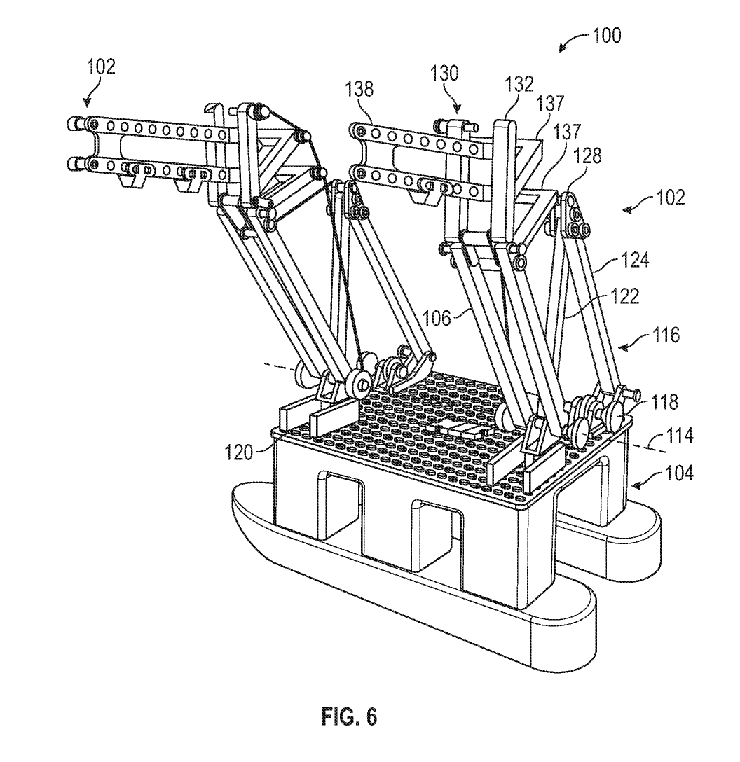

Rotation of the extension portion 132 about the horizontal axis arranged at the distal end of the main boom 106 may be controlled by a jib winch assembly 134 and a jib line 136. The jib winch assembly 134 may be arranged on the platform 120, at or near a leg of the back stay frame 116. The jib line 136 may extend from the winch assembly 134 to the extension portion 132. In some embodiments, the jib line 136 may additionally extend around or over one or more standoffs 137 via one or more sheaves. As shown in FIGS. 3 and 6 for example, one or more standoffs 137 may extend from the main boom 106 or from a portion of the jib assembly 130. Each standoff 137 may have a length similar to that of the extension portion 132 in some embodiments. The jib line 136 may extend from the jib winch assembly 134, over or across the standoff(s) 137, before its connection to the extension portion 132. In some embodiments, the crane may have one standoff 137, two standoffs, or more standoffs. The standoffs 137 may generally be configured to hold or maintain the jib line 136 away from the pivot point between the extension portion 132 and the main boom 106. In some embodiments, one or more standoffs 137 may be pivotably coupled to the main boom 106 (or to the jib assembly 130), so as to generally hold the jib line 136 away from the connection between the main boom 106 and extension portion 132 at any angle of the main boom and/or extension portion. In some embodiments, pivoting of the one or more standoffs 137 may be controlled by another winch line, such as a single layer winch, another cable management method, or a hydraulic cylinder, for example. In at least one embodiment, the crane may have a first standoff 137, and a second standoff arranged between the first standoff and the extension portion 132. The second standoff 137 may be configured to maintain a position generally centered or substantially equidistant between the extension portion 132 and first standoff 137.

In some embodiments, the jib assembly 130 may have a utility boom 138 extending from the extension portion 132. The utility boom 138 may be configured to further extend the reach of the crane 102, and may particularly be configured to extend the reach laterally. The utility boom 138 may extend laterally from a side or face of the extension portion 132 at a substantially central location along the length of the extension portion. The utility boom 138 may have a length configured to extend beyond the width of the crane to reach an extension portion of an adjacent crane. In some embodiments, where two cranes are arranged on a vessel, the utility boom 138 may have a length of approximately half the width of the vessel. In some embodiments, the utility boom 138 may have a length of approximately ½ or ⅓ that of the main boom 106. Particularly, the utility boom 138 may have a length of between approximately 17 meters and approximately 100 meters, or between approximately 25 meters and approximately 75 meters, or between approximately 33 meters and approximately 50 meters. In still other embodiments, the utility boom 138 may have a shorter or longer length, or a different length relative to the length of the main boom 106. In some embodiments, the jib winch assembly 134 and jib line 136 may be used to maintain the utility boom 138 in a substantially horizontal configuration during luffing operations. That is, the jib winch assembly 134 and jib line 136 may be independent of a luffing assembly used to luff the main boom 106, and thus may operate to draw or extend the jib 130 to any suitable angle regardless of a position or orientation of the main boom. This may be seen with reference to FIG. 3, where a first crane 102 has a lowered main boom 106, and a second crane has a main boom raised to a different angle, yet the utility booms 138 of both cranes are arranged at a substantially horizontal position.

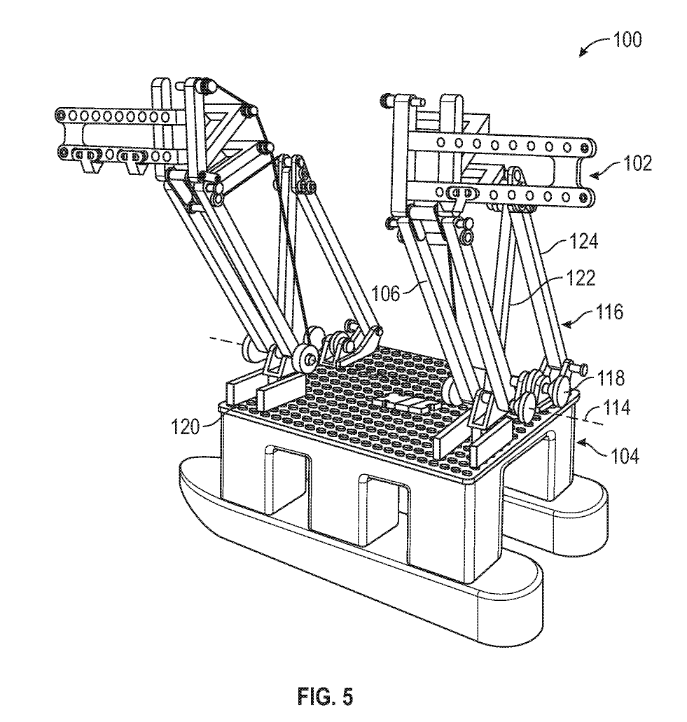

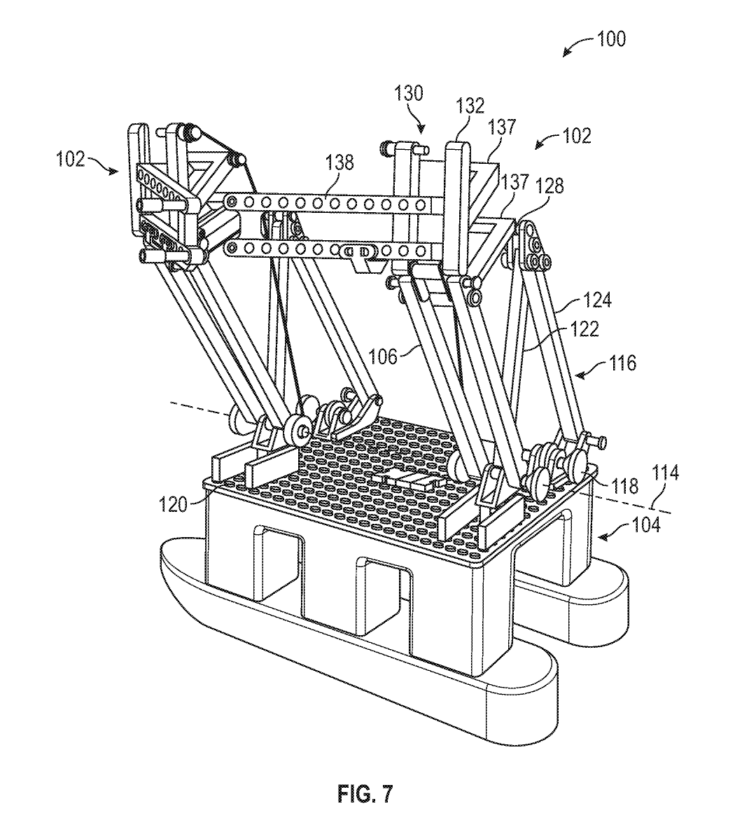

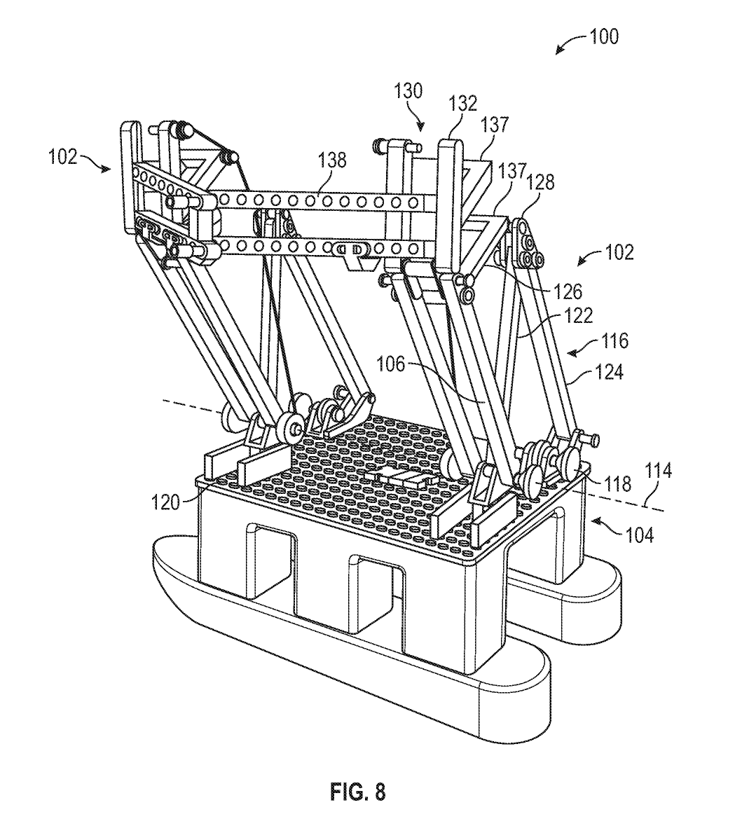

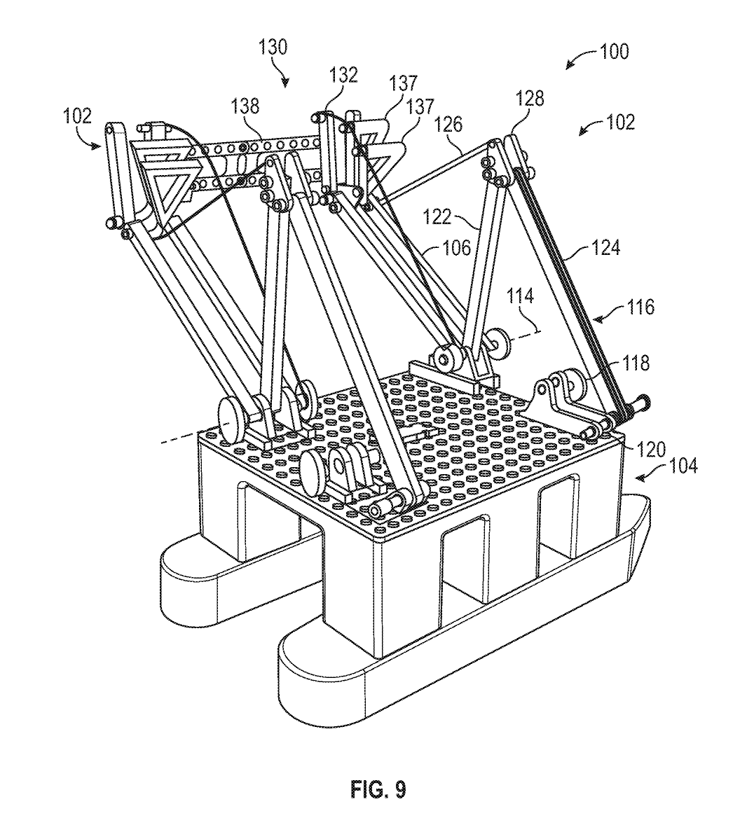

In some embodiments, the utility boom 138 may be configured to pivot about an axis 144 arranged generally perpendicular to the axis of rotation of the extension portion 132. The axis 144 may be arranged at an end of the utility boom 138, where the utility boom couples to the extension portion 132. In some embodiments, the range of rotation of the utility boom 138 may extend to approximately 150, 160, 170, or 180 degrees. In this way, the utility boom 138 may extend the reach of the crane 102 laterally, to reach loads outside of the direct line of motion of the main boom 106. As shown for example in FIG. 5, the utility boom 138 may pivot about the axis 144 toward a first side of the main boom 106. Additionally, the utility boom 138 may pivot up to approximately 180 degrees to reach an opposing side of the main boom 106. Rotation of the utility boom 138 about the axis 144 may be controlled by one or more motors, in some embodiments, or by other suitable mechanisms. As described above, the jib 130 may be configured such that the utility boom 138 may be maintained at a substantially horizontal position, independent of luffing operations of the main boom 106. In this way, the axis 144 may be maintained as a substantially vertical axis. In some embodiments, the utility boom 138 may be configured to engage with or couple to a utility boom of an adjacent crane 102, as is described elsewhere herein.

Where two cranes 102 are arranged in a tandem configuration, the cranes may be aligned to lift loads together as a unit. For example, as shown in FIG. 1, the cranes 102 may be arranged in a parallel side-by-side configuration. That is, the two cranes 102 may be aligned with their back stay frames 116 parallel. Moreover, the connection of the booms 106 to the frame 116 or platform 120 may be aligned such that the booms may pivot about the same horizontal axis 114. In this way, the two booms 106 may be luffed in a parallel configuration to hoist and/or move a load generally in front of the cranes 102. In other embodiments, tandem cranes 102 may be arranged with a different configuration. In still other embodiments, a crane system of the present disclosure may have more than two cranes 102 configured to operate as a system to hoist and/or move loads.

Where two cranes 102 are arranged in tandem, as shown for example in FIGS. 6-9, the utility booms 138 of the adjacent cranes may be configured to engage one another or to couple together. As shown in the progression of FIGS. 6-9, the utility booms 138 of the two cranes 102 may be pivoted about their substantially vertical axes 144 toward one another until the utility booms meet or connect between the two cranes. When coupled together, the utility booms 138 may thus operate as a spreader beam between the two cranes 102. This may provide additional versatility to the crane system 100 for hoisting or moving loads arranged generally between the two cranes 102.

In some embodiments, in addition to forward luffing operations, such as those described above, a crane 102 of the present disclosure may be configured for reverse luffing, which may provide for hoisting and/or moving loads generally behind the crane. That is, where forward luffing allows for rotation of the main boom 106 to positions within a first quadrant defined by a horizontal plane and a vertical plane, reverse luffing may allow for rotation of the main boom to positions within a second quadrant defined by the same horizontal and vertical planes. Put differently, where forward luffing allows for rotation of the main boom 106 within the range of approximately 0 degrees and approximately 90 degrees, as measured from a horizontal plane, reverse luffing may allow for rotation of the main boom to positions within the range of approximately 90 degrees and approximately 180 degrees, as measured from the same plane. An adjustment mechanism may be used to controllably shift the main boom from a forward luffing operation to a reverse luffing operation, and in some embodiments, to control reverse luffing. Additionally, in some embodiments, a catch may be configured to help secure, stabilize, or generally hold the main boom with respect to the back stay frame, such that the boom moves with the back stay frame.

The adjustment mechanism may be configured for transitioning the main boom 106 from a forward luffing operation to a reverse luffing operation, and may additionally be configured for controllably luffing the main boom in a rearward direction. In some embodiments, the adjustment mechanism may operate to move or guide the main boom 106 through or past a 90 degree or vertical position so as to shift the main boom from a forward luffing operation to a reverse luffing operation. For example, the adjustment mechanism 140 may operate to transition the main boom 106 from a luffing angle α of approximately 85 degrees (or just less than 90 degrees), to a luffing angle α of approximately 95 degrees (or just more than 90 degrees). Additionally, once the main boom 106 is pulled or moved past the 90 degree position, the adjustment mechanism may be configured to control reverse luffing operations. That is, the adjustment mechanism may move the main boom 106 upward and downward in a reverse or rearward luffing operation.

In some embodiments, an adjustment mechanism may include a mechanism for adjusting the back stay frame. For example, an adjustment mechanism may include a mechanism for collapsing a leg of the back stay frame, lowering a leg of the back stay frame, or sliding a leg of the back stay frame outward. In such embodiments, the adjustment mechanism may include a catch for generally securing or stabilizing the main boom 106. The catch may operate to hold the main boom 106 relatively steady with respect to the back stay frame 116 or with respect to a leg of the back stay frame. In this way, with the catch securing or stabilizing the main boom 106, as the back stay frame 116 is adjusted by the adjustment mechanism, the main boom may shift along with the back stay frame. In some embodiments, the catch may include a hard stop in the movement of the main boom 106, such that as the frame 116 is shifted, the main boom may be shifted with it. However, in other embodiments, the catch may include a pin for pinning the main boom 106 to the back stay frame 116, a hold bar extending from the back stay frame, or any other suitable mechanism for generally securing the main boom with respect to the back stay frame or with respect to a leg of the back stay frame.

In some embodiments, the adjustment mechanism may include a slidable leg of the back stay frame 116. For example, the adjustment mechanism may include a sliding frame shoe that allows a leg, such as a rear leg 124 of the back stay frame 116 to slide hack, away from the front leg 122. As the rear leg 124 slides along the platform 120, away from the front leg 122, the front and rear legs may hinge away from one another at a pivotable connection therebetween. In this way, as the rear leg 124 slides outward, the back stay frame 116 may generally flatten toward the platform 120. This adjustment of the back stay frame 116 may cause the main boom 106 to shift from a forward luffing operation, through a 90 degree or substantially vertical position, and to a reverse luffing operation. Once the main boom 106 is shifted from a forward luffing operation to a reverse luffing operation, the slidable rear leg 124 may additionally be used to control reverse luffing operations. That is, by sliding the rear leg 124 toward and away from the front leg 122, the main boom 106 may be luffed up and down in the reverse luffing operation. Similarly, in some embodiments, the adjustment mechanism may include a walkable leg of the back stay frame 116.

In other embodiments, the adjustment mechanism may include a collapsible leg of the back stay frame 116. For example, a leg, such as the rear leg 124, of the back stay frame 116 may have a telescoping mechanism, parallel sliding mechanism, or rack and pinion mechanism for collapsing or effectively shortening the rear leg. As the rear leg 124 collapses, the front 122 and rear legs may hinge away from one another at a pivotable connection therebetween, and the front leg 122 may be generally lowered or laid back toward the platform 120. This adjustment of the back stay frame 116 may cause the main boom 106 to shift from a forward luffing operation, through a 90 degree or substantially vertical position, and to a reverse luffing operation. Once the main boom 106 is shifted from a forward luffing operation to a reverse luffing operation, the collapsible rear leg 124 may additionally be used to control reverse luffing operations. That is, by extending and collapsing the rear leg 124, the main boom 106 may be luffed up and down in the reverse luffing operation.

In other embodiments, the adjustment mechanism may include a mechanism for allowing a leg of the back stay frame 116 to lower below the platform 120. For example, a leg, such as the rear leg 124, of the back stay frame 116 may be unpinned or otherwise released from its position on the platform 120, such that it may be controllably lowered off an edge or through an opening in the platform. A frame shoe may be arranged at or near an edge of the platform 120 to allow the rear leg 124 to controllably pass therethrough. In some embodiments, the line 126 may extend around or beneath the rear leg 124, such that the winch assembly 180 and line may be used to controllably lower the rear leg. In other embodiments, however, other mechanisms may be used for controllably lowering the rear leg 124. As the rear leg 124 is lowered off an edge of the platform 120, the front 122 and rear legs may hinge away from one another at a pivotable connection therebetween, and the front leg may be generally lowered or laid back toward the platform 120. This adjustment of the back stay frame 116 may cause the main boom 106 to shift from a forward luffing operation, through a 90 degree or substantially vertical position, and to a reverse luffing operation. Once the main boom 106 is shifted from a forward luffing operation to a reverse luffing operation, the rear leg 124 may be operably lowered further and raised to control reverse luffing operations.

In still other embodiments, the adjustment mechanism may include another mechanism for adjusting the back stay frame 116 to controllably shift the main boom 106 into a reverse luffing operation. In some embodiments, the adjustment mechanism may include a combination of the mechanisms described above.

In some embodiments, rather than adjusting the back stay frame 116, the back stay frame may remain stationary, and the adjustment mechanism may instead include a mechanism for pulling or pushing the main boom 106 through a 90 degree angle from a forward luffing operation to a reverse luffing operation. In such embodiments, the main boom 106 may be offset laterally from the back stay frame 116, such that as the boom is pushed or pulled through the 90 degree position into a reverse luffing operation, the back stay frame does not interfere with the motion of the boom. In other embodiments, the main boom 106 may be configured to straddle the back stay frame 116 such that the back stay frame may pass through or beneath the boom as the boom moves through the vertical position. Where the back stay frame 116 is configured to remain stationary, the adjustment mechanism may be configured to controllably move the main boom 106 from a forward luffing position (such as from a luffing angle of approximately 85 degrees) to a reverse luffing position (such as to a luffing angle of approximately 95 degrees). In this way, the adjustment mechanism may include one or more gears arranged on the main boom 106 and configured to engage a gear bar extending from the back stay frame 116. Once the main boom 106 is forward luffed to a luffing angle of approximately 85 degrees or otherwise to a near-vertical position, the gear(s) may engage with the gear bar to walk the main boom through the 90 degree position and into a reverse luffing position with a luffing angle of more than 90 degrees. The gear(s) may be controlled using one or more motors, for example. In other embodiments, one or more hydraulic cylinders may be used to push or pull the main boom 106 through the 90 degree position. In still other embodiments, other mechanisms may be used to controllably shift the main boom 106 from a forward luffing position to a reverse luffing position. In some embodiments, once the main boom 106 is moved past the 90 degree position, or is otherwise shifted to a reverse luffing position, the winch assembly 118 and line 126 may be used to control reverse luffing of the main boom. In other embodiments, another mechanism may be used to control luffing in the reverse luffing operation.

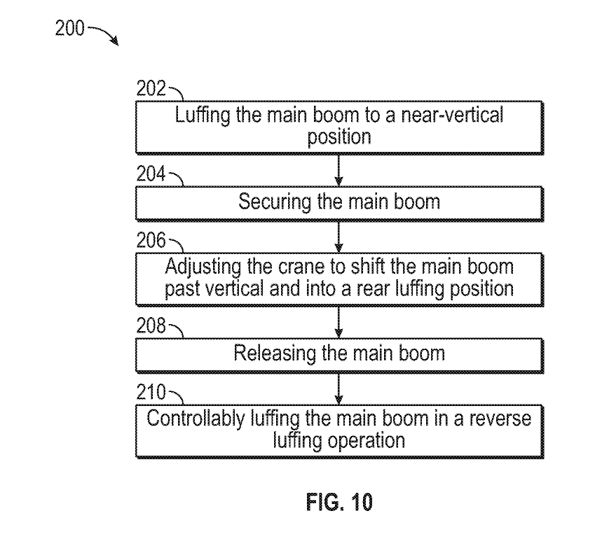

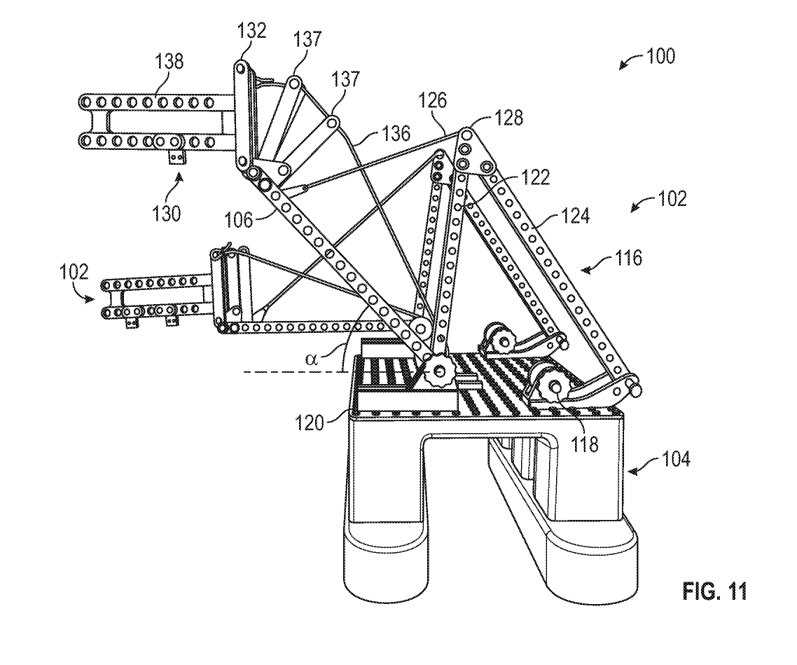

Turning now to FIG. 10, a method 200 of shifting a crane of the present disclosure from a forward luffing operation to a reverse or rearward luffing operation is shown. As shown, the method 200 may include the steps of: in a forward luffing operation, luffing the main boom to a near-vertical position 202; securing the main boom 204; adjusting the crane to shift the main boom past vertical and into a rear luffing position 206; and controllably luffing the main boom in a reverse luffing operation 210. FIGS. 11-15 illustrate the steps of the method 200, according to some embodiments. In some embodiments, the main boom may be unloaded while performing the method 200. However, in other embodiments, the boom may be carrying a load.

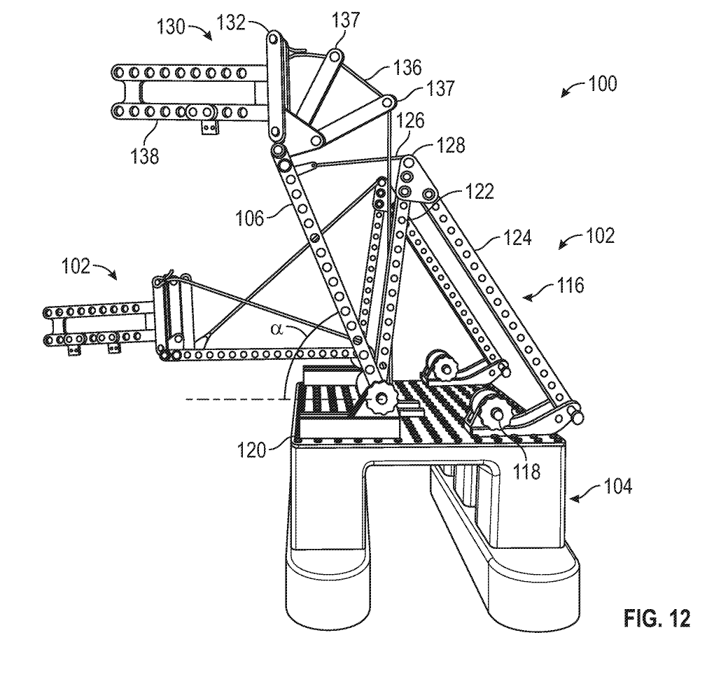

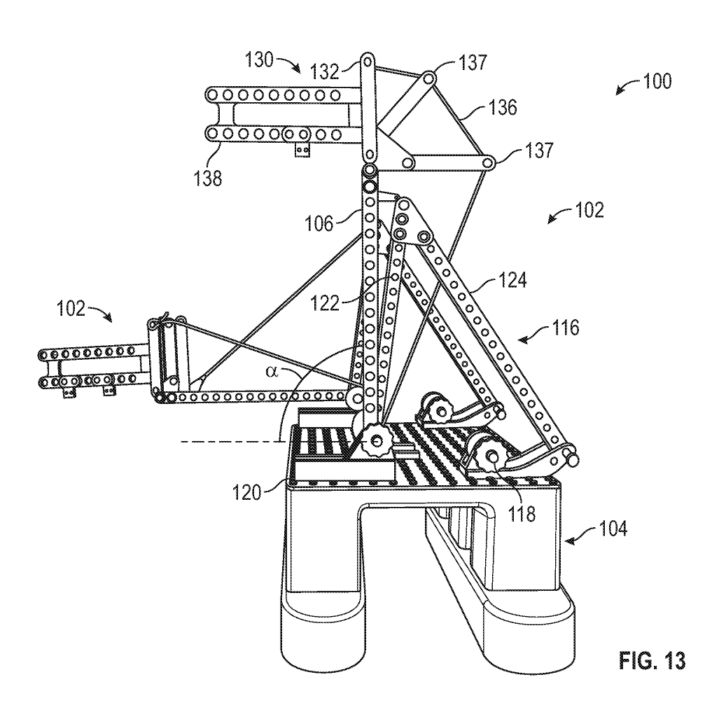

As indicated above, the method 200 may include, in a forward luffing operation, luffing the main boom to a near-vertical position 202. In this way, the main boom may be forward luffed to a maximum or near maximum forward luffing angle, beyond which the main boom may become relatively unstable or uncontrolled. This maximum or near maximum angle may be a luffing angle α of between approximately 70 degrees and approximately 90 degrees, or between approximately 80 and 90 degrees, or between approximately 85 and 90 degrees. FIG. 11 illustrates the crane system 100 in which tandem cranes 102 are being operated in a forward luffing operation. FIG. 12 illustrates the system 100 with the main boom 106 of a first crane 102 being luffed up and toward the near-vertical luffing angle α. FIG. 13 illustrates the system 100 with the main boom 106 arranged at the maximum or near maximum forward luffing position, with a luffing angle α of between approximately 80 degrees and approximately 90 degrees.

With continued reference to the method 200 of FIG. 10, in some embodiments, the main boom may be secured 204 upon reaching the near-vertical position, using a catch. Securing the main boom may help to stabilize the boom as the crane is shifted from forward luffing to reverse luffing. For example, the catch may include a mechanism for pinning, or otherwise removably coupling, the main boom to the back stay frame. In some embodiments, the catch may include a stop or a mechanism for merely holding the back stay frame against the back stay frame or ensuring tightness or tension in the luffing line or cable. In some embodiments, a strut, which may be a temporary strut, may be used to help secure the main boom to the back stay frame. The boom may be coupled to, or held against, the front leg, rear leg, or another portion of the back stay frame. In general, the main boom may become relatively unstable at angles near or approaching 90 degrees from horizontal. Securing the boom to, for example, the back stay frame, may help to stabilize the boom to safely transition the boom through and over the 90 degree position. In some embodiments, however, the main boom may be moved from forward luffing to reverse luffing without being secured.

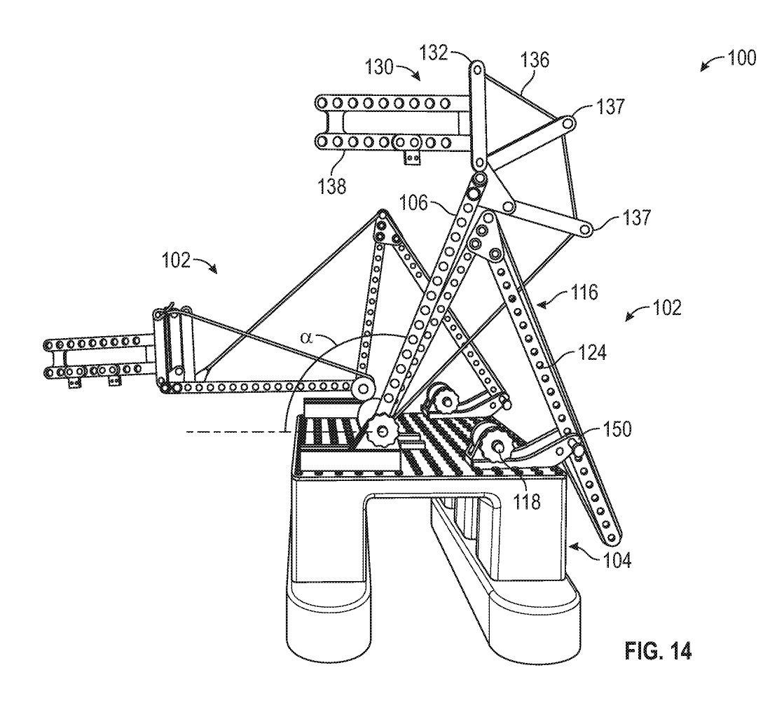

The method 200 may include adjusting the crane to shift the main boom past vertical and into a rear luffing position 206, using an adjustment mechanism. An adjustment mechanism may be used to adjust the crane by adjusting the main boom directly to move it to a rear luffing position, or to adjust the back stay frame to thereby cause a shift of the main boom. In some embodiments, an adjustment mechanism may be used to adjust the back stay frame by lowering a leg of the back stay frame off an edge or through an opening in the platform. For example, as shown in FIG. 14, the adjustment mechanism may include a frame shoe 150 for allowing the rear leg 124 of the back stay frame 116 to pass therethrough, such that the rear leg may be lowered off an edge of the platform 120. In this way, the frame shoe 150 may be arranged at or near an edge of the platform 120. The rear leg 124 may be unpinned or otherwise released from the platform 120, such that it may slide through the frame shoe 150. Movement of the rear leg 124 through the frame shoe 150 may be controlled using the winch assembly 118 in some embodiments, where the line 126 extends around the released end of the rear leg 124. For example, as the line 126 is let out from the winch assembly 118, the rear leg 124 may controllably pass through the frame shoe 150, and below the platform 120. As the line 126 is pulled by the winch assembly 118, the rear leg 124 may pulled up through the frame shoe 150, above the platform 120. In other embodiments, other mechanisms may be used to control movement of the rear leg 124 through the frame shoe 150. As the rear leg 124 is lowered through the frame shoe 150, the front leg 122 together with the secured main boom 106 may be pulled back and down toward the platform 120. In particular, adjusting the back stay frame 116 in this way may shift the top or apex of the A-frame back toward the rear leg 124, decreasing the included angle x between the front leg 122 and platform 120, and increasing the included angle z between the front leg and the rear leg 124. (Angles x, y, and z are illustrated in FIG. 2.) In this way, the adjustment mechanism, which may include the frame shoe 150, may shift the main boom 106 from a luffing angle α of less than 90 degrees to an angle of at least or more than 90 degrees.

As generally described above, in other embodiments, the adjustment mechanism may be or include a collapsible or slidable leg of the back stay frame 116. For example, the rear leg 124 of the back stay frame 116 may have a telescoping mechanism, parallel sliding mechanism, or rack and pinion mechanism for collapsing or effectively shortening. As the rear leg 124 is shortened or collapsed, the front leg 122 and main boom 106 may be generally pulled back and down toward the platform 120, as described above with respect to FIG. 14. In still other embodiments, the adjustment mechanism may include a mechanism for pushing or pulling the main boom 106 through the 90 degree position.

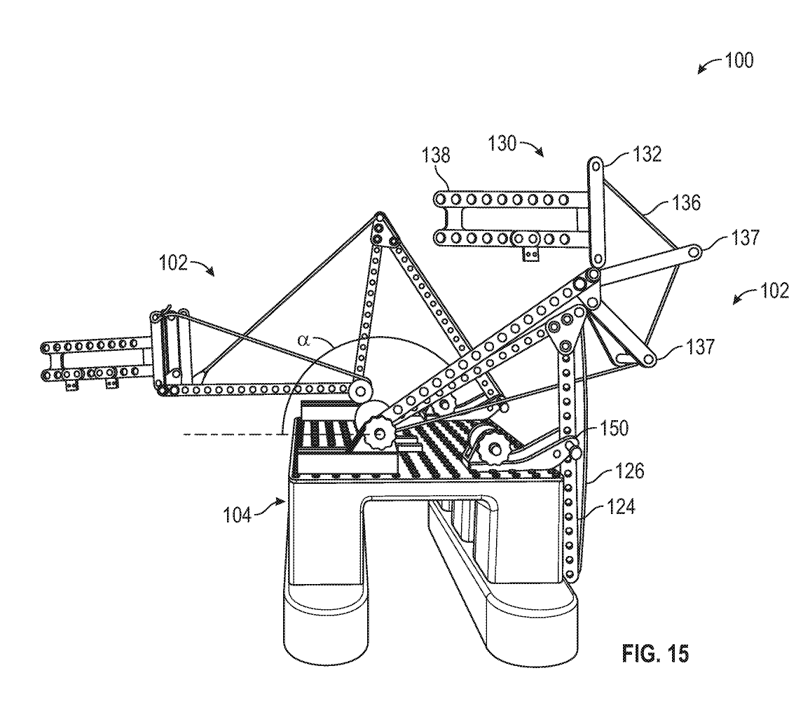

With continued reference to FIG. 10, once the main boom is moved through or past a 90 degree angle, the boom main be controllably luffed in a reverse luffing operation 210. In some embodiments, reverse luffing may be controlled by the same adjustment mechanism used to adjust the crane from a forward luffing operation. For example, as shown in FIG. 15, where the adjustment mechanism includes a frame shoe 150 for allowing the rear leg 124 of the back stay frame to pass therethrough, continued lowering and raising of the rear leg through the frame shoe may allow provide reverse luffing operations. That is, the winch assembly 118 may be used to raise and lower the rear leg 124 through the frame shoe 150, thus additionally raising and lowering the boom 106 secured to the frame 116. In other embodiments, other mechanisms may be used to control reverse luffing. For example, one or more hydraulic rams may be used to control raising and lower of the main boom 106 in the reverse luffing operation. The one or more hydraulic rams may engage with the main boom 106 and/or the rear leg 124, for example.

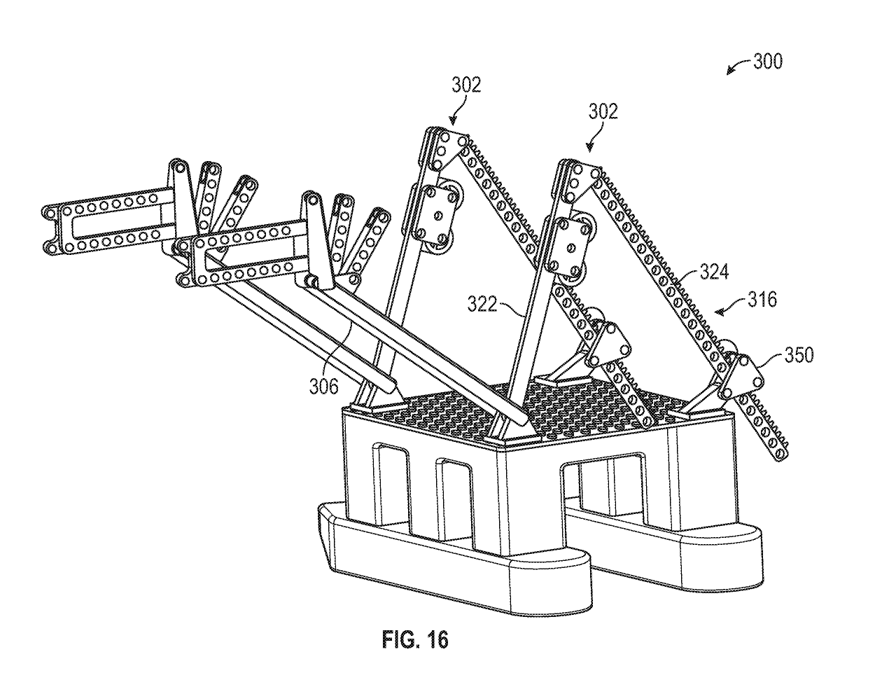

FIG. 16 shows another embodiment of a crane system 300 of the present disclosure having a pair of tandem cranes 302. As shown, for each crane 302, the rear leg 324 of the back stay frame 316 may have adjustment mechanism comprising a jacking system 350 for shifting the crane from a forward luffing operation to a reverse luffing operation, and/or for controlling reverse luffing of the main boom 306.

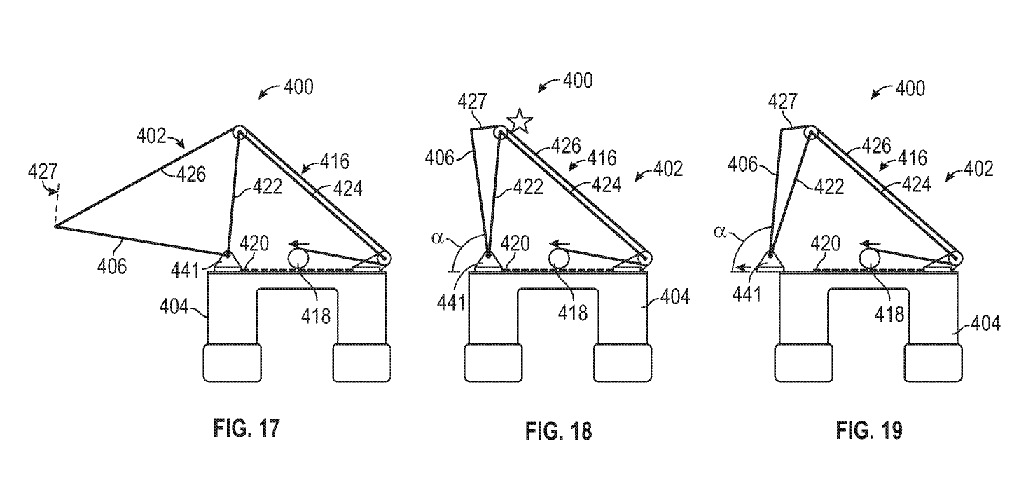

Turning now to FIGS. 17-22, a crane system 400 having an alternate adjustment mechanism and adjustment mechanism is shown. The crane system 400 may have one or more cranes 402 arranged on a platform 420 of a support base 404. Each crane 402 may have a main boom 406 having a proximal end at or near the platform 420 and an opposing distal end. The main boom 406 may be configured to pivot about a substantially horizontal axis at or near the proximal end of the main boom. A back stay frame 416 having a front leg 422 and a rear leg 424 may be arranged on the platform 420. A winch assembly 418 and a cable or line 426 may be used to pivot the main boom 406 about the horizontal axis for forward luffing operations. In some embodiments, the crane 402 may have a strut 427, which may be a temporary strut, for securing the main boom 406 to the back stay frame 416 during a transition from forward luffing operations to reverse luffing operations.

As shown in FIG. 18, to transition the crane 402 from forward luffing operations to reverse luffing operations, the main boom 406 may be luffed in a forward operation to an included angle of between approximately 80 degrees and approximately 90 degrees, or an angle of approximately 85 degrees from horizontal. The temporary strut 427 may be used to pin or otherwise secure the main boom 406 to the back stay frame 416.

As shown in FIG. 19, the adjustment mechanism may include a sliding or skidding frame shoe 441 on the front leg 422 of the back stay frame 416, the frame shoe 441 configured to slide or skid along the platform 420. Movement of the front leg 422 along the platform 420 may cause the front leg to pivot at its connection to the rear leg 424. As the frame shoe 441 moves the front leg 422 along the platform away from the rear leg 424, an included angle between the front leg and the platform 420 may decrease, and an included angle between the front leg and the rear leg may increase, as the front and rear legs pivot away from one another. The adjustment to the frame 416 may cause the main boom 406, secured to the frame, to shift from a luffing angle of less than 90 degrees to a luffing angle of at least or more than 90 degrees. In some embodiments, the frame shoe 441 may be skidded or slid until the main boom 406 reaches an angle of at least 90 degrees, more than 90 degrees, or of approximately 95 degrees.

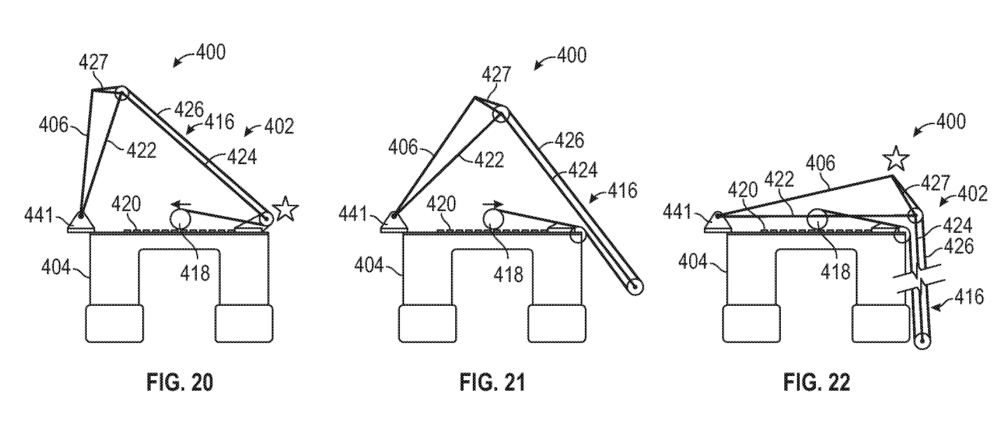

FIGS. 20-22 illustrate a reverse luffing operation of the crane system 400, according to some embodiments. To control reverse luffing, the rear leg 424 of the back stay frame 416 may be unpinned or otherwise decoupled or released from the platform 420. With the rear leg 424 decoupled from the platform 420, it may be held by tension in the line 426 and may be free to lower using the winch assembly 418. As shown in FIGS. 21-22, letting out the line 426 from the winch assembly 418 may cause the rear leg 424 to lower off an edge (or through an opening in) the platform 420. As the rear leg 424 is lowered, the main boom 406 may be drawn down toward the platform 420 in a reverse luffing operation. Similarly, taking in or spooling the line 426 on the winch 418 may raise the main boom 406 in the reverse luffing operation.

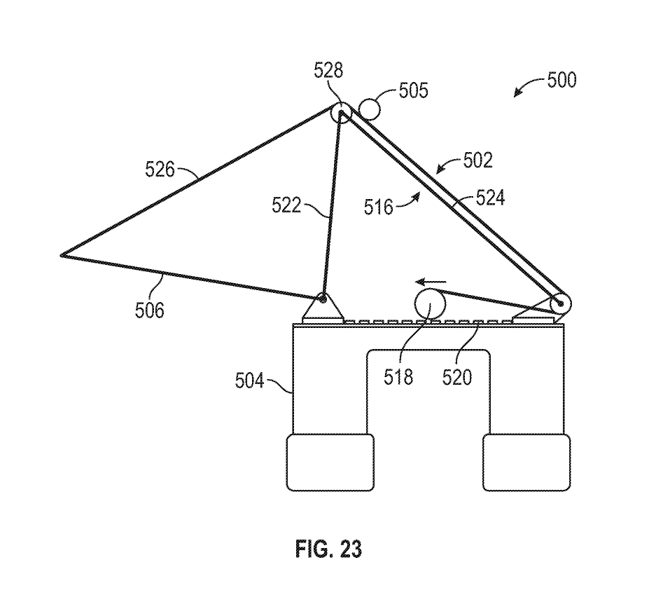

In still other embodiments, reverse luffing may be controlled by other mechanisms. For example, in some embodiments, a crane may have a reverse luffing sheave assembly configured to engage with the line as the main boom is luffed in the reverse direction. Turning for example to FIG. 23, a crane system 500 having a crane 502 with a pivotable main boom 506 and a back stay frame 516 with front 522 and rear 524 legs is shown. The crane 502 may have a winch assembly 518 and a line 526 for luffing the main boom 506. The line 526 may extend through or across a sheave assembly 528, which may be a forward luffing sheave assembly at or near a top of the back stay frame 516 where the front 522 and rear 524 legs meet. In addition, the crane 502 may have a reverse luffing sheave assembly 505 arranged on the back stay frame 516. The reverse luffing sheave assembly 505 may be arranged at or near a top of the back stay frame 516, near the forward luffing sheave assembly 528. The reverse luffing sheave assembly 505 may be positioned and configured to engage the line 526 during reverse luffing operations. For example, an adjustment mechanism, such as those discussed above, may be used to shift the main boom 506, directly or indirectly via the frame, from a luffed angle of less than 90 degrees to a luffed angle of more than 90 degrees. Once the main boom 506 reaches an angle of more than 90 degrees, or an angle of 95 degrees in some embodiments, the line 526 may tend to pull away from the forward luffing sheave assembly 528. The rear luffing sheave assembly 505 may be positioned and configured to catch or engage the line 526 as the line departs from the forward luffing sheave assembly 528. In this way, the reverse luffing sheave assembly 505 may be configured to generally reverse a direction of the line 526 such that the line and winch assembly 518 may operate to control reverse luffing operations. In such embodiments, the adjustment mechanism used to shift the main boom 506 from a forward luffing position to a reverse luffing position may be the winch assembly 518. For example, the winch assembly 518 may continue to pull in the line 526 to bring the main boom 506 through the vertical until the line disengages with the forward luffing sheave assembly 528 and engages with the reverse luffing sheave assembly 505.

It is to be appreciated that the methods described above for shifting a crane of the present disclosure from a forward luffing operation to a reverse or rearward luffing operation may generally be reversed to shift the crane from a reverse or rearward luffing operation to a forward luffing operation. For example, to transition from reverse luffing to forward luffing, the main boom of a crane of the present disclosure may be reverse luffed up to a vertical or near vertical position. In some embodiments, the crane may be luffed to a luffed angle of between approximately 90 degrees and 110 degrees, or between 90 degrees and 100 degrees, or between 90 degrees and 95 degrees. In some embodiments, the main boom may be luffed to a position of approximately 95 degrees. The main boom may then be secured using, for example, the same device or mechanism used to secure the main beam when transitioning from forward luffing to reverse luffing. The crane may be adjusted via an adjustment mechanism, as described above, to shift the main boom past vertical and into a forward luffing position. For example, where the adjustment mechanism is a collapsible leg of the back stay frame, the leg may be extended or lengthened to shift the main boom from a reverse luffing position to a forward luffing position. Similarly, where the adjustment mechanism is a sliding leg of the back stay frame, the leg may be slid back to a forward luffing position to shift the main boom. In some embodiments, the main boom may then be released from its secured position, and the main boom may be controllably luffed in a forward luffing operation.

As described above, a crane of the present disclosure may be configured to operate using both forward luffing operations and reverse luffing operations. In this way, a crane of the present disclosure may have a relatively wide area of operation. In some embodiments, a crane of the present disclosure may have a main boom operable within a 180-degree range of motion, from a horizontal or near horizontal position in a forward luffing operation to a horizontal or near horizontal position in a reverse luffing operation. In this way, a crane of the present disclosure may provide up to twice the operating range of a conventional shear leg crane. Moreover, the addition of a utility boom to a crane of the present disclosure, as described above, may increase the versatility and operational range of the crane. In particular, a utility boom may effectively extend the reach of the crane, by allowing the crane to reach lateral locations.

In addition, a crane of the present disclosure may be a relatively high lift capacity crane. For example, in some embodiments, a crane of the present disclosure may have a lift capacity of up to 12,500 tons or more. Thus, a tandem crane system of the present disclosure may have a combined lift capacity of up to, for example, 25,000 tons or more. In this way, a crane or crane system of the present disclosure may provide for a relatively versatile crane or system having a relatively wide range of motion and a relatively high lift capacity, as compared with other cranes. A crane or crane system of the present disclosure may be used in a variety of applications. However, a crane or crane system of the present disclosure may be particularly useful in an offshore operation, where a tandem crane system may be used to load/unload equipment to and from a vessel, and to move equipment to various positions on a deck of the vessel.

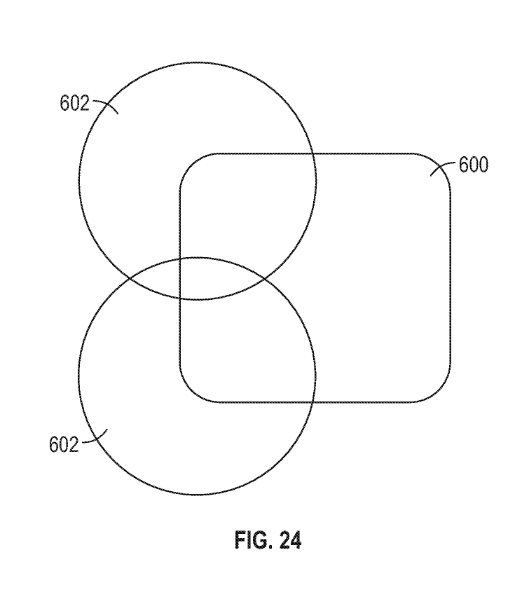

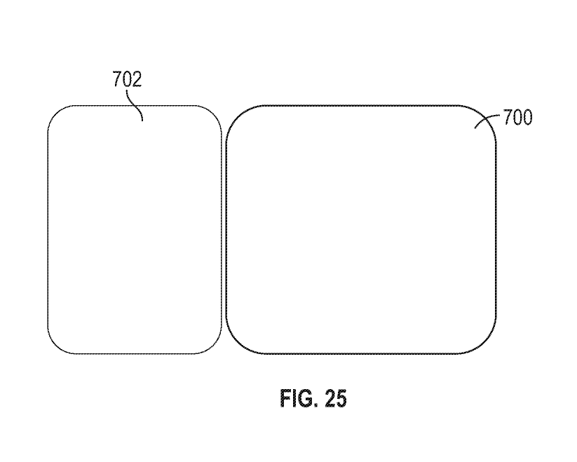

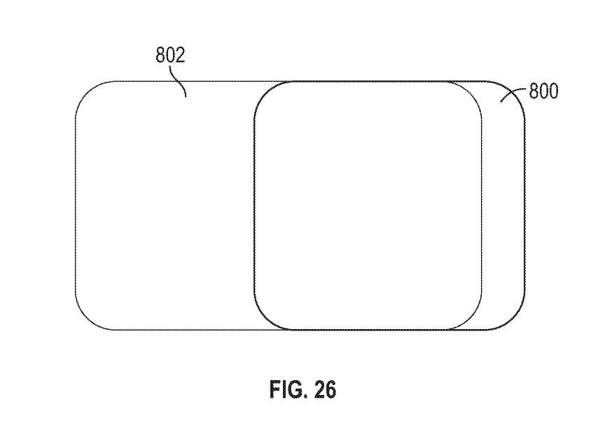

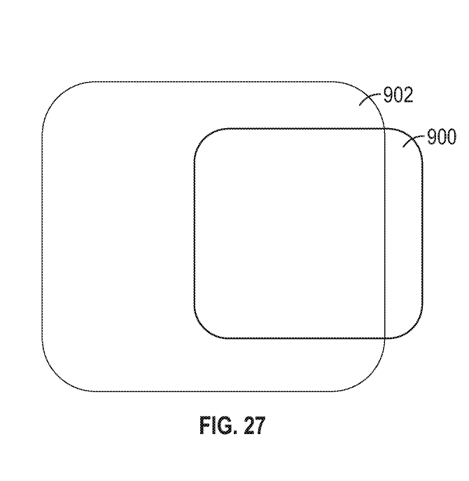

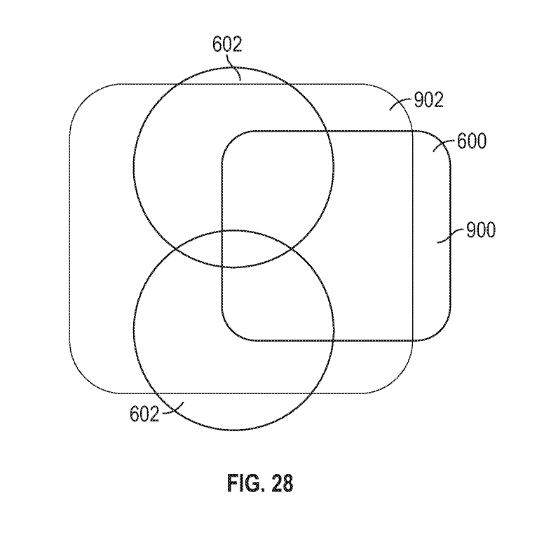

FIGS. 24-28 illustrate operational areas of various types of crane systems, as compared with a crane system of the present disclosure to illustrate the benefits. In particular, FIG. 24 illustrates an operational area of a crane system 600 of conventional tandem rotational cranes, such as mast cranes. As shown, each rotational crane may have a circular operational area 602. The two circular operational areas may overlap, as the system may be limited by the reach of the cranes. FIG. 25 shows an operational area of a crane system 700 of conventional shear leg cranes. As shown, the tandem system 700 may have a rectangular or square operation area 702 arranged generally on one side of the system. This rectangular or square-shaped operational area 702 may generally be position in front of the tandem cranes, as conventional shear leg cranes typically luff in one direction or on one side of the system. FIG. 26 shows an operational area of a crane system 800 of the present disclosure with a pair of cranes operable in both a forward luffing and a reverse luffing operation. As compared with the operational area 702 of FIG. 25, the operational area 802 of the system 800 may extend across and overlap with the crane system 800 itself. The added utility of the reverse luffing operations may allow the crane system 800 to operate across longer range of motion. The operational area 802 of the crane system 800 may be approximately twice the size of the operational area 702 of a conventional tandem shear leg crane system. FIG. 27 shows an operational area of a crane system 900 of the present disclosure with a pair of cranes operable in both a forward luffing and reverse luffing operation, and with added utility booms, as described above. The addition of utility booms to the cranes may provide a wider reach for the crane system, thus widening the area of operation 902. Finally, FIG. 28 shows a comparison of the operational area 602 the system 600 of conventional tandem rotational cranes with the operational area 902 of the system 900 of tandem cranes of the present disclosure configured for forward and reverse luffing, and having utility booms. As may be appreciated from FIG. 27, a crane system of the present disclosure may provide more operability and versatility than conventional rotational crane systems or other crane systems.

Various embodiments of the present disclosure may be described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks. Alternatively, computer program implemented steps or acts may be combined with operator or human implemented steps or acts in order to carry out an embodiment of the invention.

Additionally, although a flowchart or block diagram may illustrate a method as comprising sequential steps or a process as having a particular order of operations, many of the steps or operations in the flowchart(s) or block diagram(s) illustrated herein can be performed in parallel or concurrently, and the flowchart(s) or block diagram(s) should be read in the context of the various embodiments of the present disclosure. In addition, the order of the method steps or process operations illustrated in a flowchart or block diagram may be rearranged for some embodiments. Similarly, a method or process illustrated in a flow chart or block diagram could have additional steps or operations not included therein or fewer steps or operations than those shown. Moreover, a method step may correspond to a method, a function, a procedure, a subroutine, a subprogram, etc.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an element may still actually contain such element as long as there is generally no significant effect thereof.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

What is claimed is:

1. A reverse luffing crane, comprising:
a crane boom extending from a proximal end at or near a base to a distal end and being pivotable about a substantially horizontal axis at the proximal end;
a luffing assembly configured for pivoting the crane boom about the axis, the assembly comprising:
a back stay frame; and
a winch assembly configured for controlling the pivoted position of the crane boom relative to the back stay frame; and
an adjustment mechanism configured to controllably transition the crane boom from a forward luffing position to a rearward luffing position, the adjustment mechanism comprising:
a catch for controlling the rearward motion of the crane boom relative to the back stay frame.

2. The crane of claim 1, wherein the luffing assembly secures the crane boom to the catch and maintains the relative position of the crane boom to the catch while it transitions from forward to reverse luffing.

3. The crane of claim 1, wherein the adjustment mechanism includes a mechanism for lowering a leg of the back stay frame.

4. The crane of claim 1, wherein the adjustment mechanism includes a collapsible leg of the back stay frame.

5. The crane of claim 4, wherein the collapsible leg is a telescoping element.

6. The crane of claim 4, wherein the collapsible leg is a parallel sliding mechanism.

7. The crane of claim 1, wherein the adjustment mechanism includes a frame shoe configured to allow a leg of the back stay frame to controllably pass therethrough.

8. The crane of claim 7, wherein the luffing assembly is configured to control the motion of the leg and the resulting reverse motion of the crane boom.

9. The crane of claim 1, further comprising a utility boom extending generally laterally from the crane boom and arranged at or near the distal end.

10. The crane of claim 9, wherein the utility boom is pivotable about a generally vertical axis.

11. The crane of claim 9, wherein the utility boom is configured to engage a second utility boom extending from an adjacent crane.

12. A shear leg crane, comprising:
a crane boom extending from a proximal end at or near a base to a distal end and being pivotable about a substantially horizontal axis at the proximal end;
a luffing assembly configured for pivoting the crane boom about the axis, the assembly comprising:
a back stay frame; and
a winch assembly configured for controlling the pivoted position of the crane boom relative to the back stay frame; and
a utility boom extending generally laterally from the crane boom and arranged at or near the distal end, the utility boom being pivotable about a generally vertical axis.

13. The crane of claim 12, wherein the utility boom is configured to engage a second utility boom extending from an adjacent crane.

14. The crane of claim 12, further comprising an adjustment mechanism configured to controllably transition the crane boom from a forward luffing position to a rearward luffing position, the adjustment mechanism comprising:
a catch for controlling the rearward motion of the crane boom relative to the back stay frame.

15. The crane of claim 14, wherein the adjustment mechanism includes a collapsible leg of the back stay frame.

16. The crane of claim 14, wherein the adjustment mechanism includes a frame shoe configured to allow a leg of the back stay frame to controllably pass therethrough.

17. A method of operating a shear leg crane having a crane boom pivotable about a substantially horizontal axis and a luffing assembly configured for pivoting the crane boom about the axis, the method comprising:
in a forward luffing operation, luffing the main boom to a near-vertical position;
securing the main boom;
controllably transitioning the crane boom from a forward luffing position to a rearward luffing position; and
controllably luffing the main boom in a reverse luffing operation.

18. The method of claim 17, wherein the luffing assembly comprises a back stay frame, and controllably transitioning the crane boom from a forward luffing position to a rearward luffing position comprises lowering a leg of the back stay frame.

19. The method of claim 17, wherein the luffing assembly comprises a back stay frame, and controllably transitioning the crane boom from a forward luffing position to a rearward luffing position comprises collapsing a leg of the back stay frame.

20. The method of claim 17, wherein the luffing assembly comprises a back stay frame, and controllably transitioning the crane boom from a forward luffing position to a rearward luffing position comprises controllably passing a leg of the back stay frame through a frame shoe.
